(19) United States
(12) Patent Application Publication
(10) Pub. No.: US 2009/0263111 A1
(43) Pub. Date: Oct. 22, 2009

(54) STEAMER HEAD AND APPARATUS FOR STRIPPING WALLPAPER

(76) Inventors: Yaron Meshoulam, London (GB); Yair Meshoulam, London (GB)

Correspondence Address: PEARNE & GORDON LLP, 1801 EAST 9TH STREET, SUITE 1200, CLEVELAND, OH, 44114-3108, US

(21) Appl. No.: 11/911,245

(22) PCT Filed: Apr. 12, 2006
(86) PCT No.: PCT/GB06/01322

§ 371 Date: May 1, 2008

(30) Foreign Application Priority Data
Apr. 18, 2005 (GB) 0507848.0

(51) Int. Cl. B44C 7/02

(52) U.S. Cl. 392/392; 7/105

(57) ABSTRACT

A steamer head for steaming surface coverings comprises a body and coupling means couplable to a support member to support the steamer head against a surface. The steamer head can be used with a support member to form a steamer apparatus. In one embodiment, the support member includes a paint roller whereby the roller mount of the paint roller is inserted into openings in the body of the steamer head.

The present invention relates to a steamer apparatus for use in steaming surface coverings, for example paper, on surfaces such as walls or ceilings.

Steamers which can be used to apply steam to a wall covering are known. They have become popular both with commercial decorators and domestic users, since they reduce the physical labour required to strip a wall covering from a wall by loosening the wall covering from the wall.

Known steamers generally include a steam production unit which produces and feeds steam to a steamer head via a tube. The steamer head is provided with a handle for the user to grip so that he can hold the steamer head against a wall. To operate the steamer, the user uses one of his hands to hold the steamer head against a portion of a wall which is to be stripped of its covering. The steamer head must be held in position against the wall for a period long enough to allow the wall covering to be sufficiently loosened from the wall by the action of the steam. It is not unusual for this to take a couple of minutes.

The user then removes the steamer head from the wall and uses an implement such as a scraper to scrape the wall covering from the wall. It is common for the user to hold the scraper in one hand whilst holding the steamer head in his other hand.

When the user has finished scraping the wall covering from that portion of the wall, he repeats the procedure by placing the steamer head against a different portion of the wall for a couple of minutes.

Known steamers suffer from the disadvantage that the user quickly becomes exhausted from holding the steamer head against the wall, particularly since much of the wall to be steamed is not at a height which is comfortable for the user.

Additionally, this process is restrictive and time consuming since the steamer head must be held by the user in position against each portion of the wall in turn. Use of the steamer is cumbersome since both hands are required, one to hold the steamer head and one to hold the scraper.

It is known to hold the steamer head in one hand against one portion of the wall whilst simultaneously scraping the wall covering from a different portion of the wall with the other hand. However, when the user concentrates on scraping the wall covering from one portion of the wall, he may inadvertently allow the steamer head to move, or become partly separated from the wall, which reduces the effectiveness of the steam action on the wall covering.

According to the present invention, a steamer head for steaming surface coverings comprises a body and coupling means couplable to a support member to support the steamer head against a surface.

By providing the steamer head with coupling means, the steamer head can be coupled to a support member which removes the need for the user to hold the steamer head against the surface. This is therefore advantageous since the user does not become exhausted from holding the steamer head against the surface, and the user can move away from the supported steamer head to do other activities. Such other activities are usually in the same room to ensure safe operation of the steamer apparatus.

The coupling means may comprise a female coupling device or a male coupling device which is couplable respectively to a male coupling device or a female coupling device of the support member. Providing a device with a female or male coupling device is readily done and results in an easy to use and reliable coupling device.

In a preferred embodiment, the coupling means comprises a female coupling device which is an opening extending at least partially through the body, the opening being sized and shaped such that the male coupling device of the support member is frictionally engagable with the inner surface of the opening. Providing an opening in the body has the advantage that the steamer head can be less cumbersome for storing and handling. For example, the handle is not obstructed by the opening in the body. The male coupling device may be a roller mount or roller head of a paint roller.

Alternatively, the female or male coupling device may be secured to a face of the body. This may be preferred for ease of production of the steamer head.

The female or male coupling device is advantageously sized and shaped such that it is frictionally engagable respectively with the male or female coupling device of the support member. This is a simple mechanism for coupling the steamer head to the support member. For a more secure coupling, the female coupling device or male coupling device may be provided with a threaded surface which is couplable respectively to a threaded surface on the male coupling device or female coupling device of the support member.

The female or male coupling device is optionally moveably mounted on the steamer head, for example rotatably or pivotably mounted. This has the advantage that the steamer head can be moveable relative to a support member coupled thereto, which enables, in use, the support member to support the steamer head against a high region of a wall as well as against a lower region of the wall.

In one example, the female or male coupling device is mounted on a two-way pivot joint. In this way, the steamer head can be pivotable about two pivot axes relative to a support member coupled thereto. This additional movement increases the flexibility of use of the steamer head.

Optionally, the coupling means may comprise a second female or male coupling device of different dimensions to the first female or male coupling device. In this way, the steamer head can be coupled to support members having male or female coupling devices of different dimensions.

According to a second aspect of the invention, a steamer apparatus for steaming surface coverings comprises the steamer head described above coupled to a support member for supporting the steamer head against a surface.

The steamer head and the support member are optionally pivotable relative to each other. This may be achieved by moveably mounting the female or male coupling device of the steamer head to the body, as described above. Alternatively, this may be achieved by providing a moveable part on the support member. For example, a two-way pivot joint may be provided on the support member instead of on the body.

To enable the support member to be coupled to the steamer head, when the steamer head is provided with the female coupling device the support member is provided with a male coupling device, and when the steamer head is provided with the male coupling device the support member is provided with a female coupling device.

Preferably, when the steamer head has a female or male coupling device provided with a threaded surface, the male or female coupling device of the support member is also provided with a threaded surface.

The support member may include a shaft having a first end which is provided with the male coupling device. In one embodiment, the male coupling device extends in a transverse direction relative to the shaft. In this way, the transversely extending male coupling device of the support member may be inserted in the opening in the body of the steamer head to couple the steamer head and the support member together.

The male coupling device can be rotatably mounted on the first end such that its axis of rotation is generally perpendicular to the shaft, thus enabling the steamer head to be pivotable relative to the shaft.

Advantageously, the shaft is generally aligned with the centre of the steamer head. This increases the stability of the apparatus in use, particularly against slippage sideways along a wall. Where the male coupling device on the support member extends in a transverse direction relative to the shaft, the first end is preferably configured so as to enable the axis of the shaft to be generally aligned with the centre of the steamer head.

In a preferred embodiment, the first end may be the handle and neck of a paint roller and the male coupling device may be the roller mount or roller head of a paint roller, the handle being separably coupled to the shaft. Use of a paint roller coupled to the steamer head is particularly advantageous. The construction of known paint rollers has been found to result in an arrangement which allows the steamer head to pivot relative to the handle of the roller, whilst not requiring expensive additional component parts. Thus the roller head can be inserted into the opening in the steamer head, or the roller head can be removed from the roller mount such that the roller mount engages the opening in the steamer head.

For ease of use and storage, the support member can be separably coupled to the steamer head. The length of the support member is preferably adjustable. This is useful both for ease of storage as well as to allow the steamer head to be moved from a high region of a wall to a lower region in use, without having to move the end of the support member contacting the ground away from the base of the wall.

In an alternative embodiment, the male coupling device on the support member may be frictionally engaged with the opening in the body so as to couple the support member to the steamer head whilst allowing the male coupling device to rotate within the opening. Such an arrangement allows the steamer head to be pivotable relative to the support member without the need for other moving parts.

Embodiments of the present invention will now be described, by way of example only, with reference to the following drawings in which:

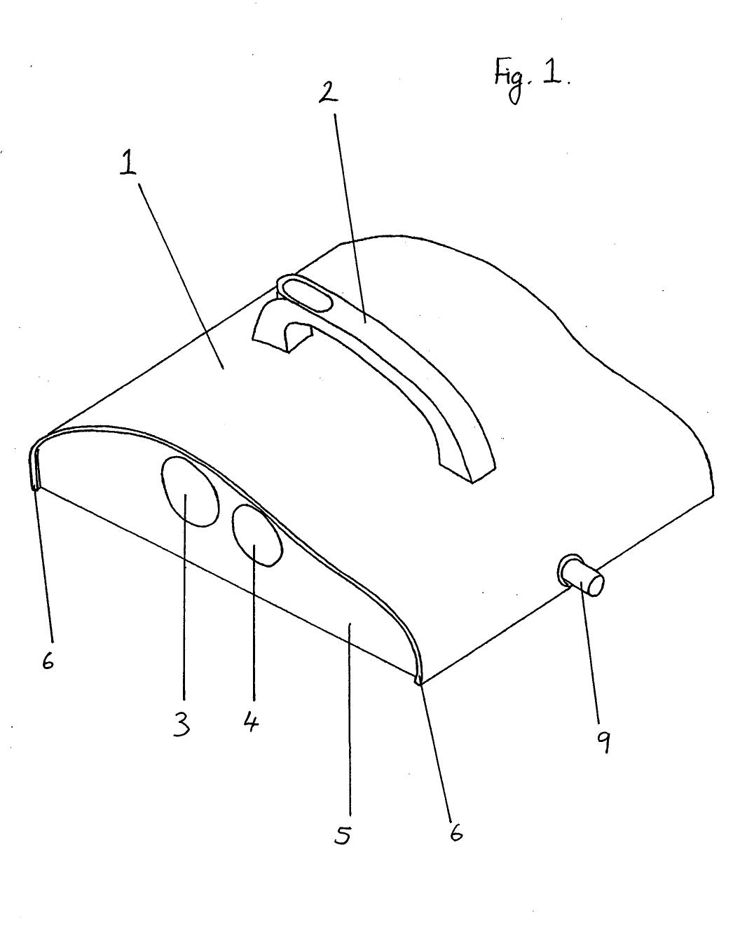

FIG. 1 is a perspective view of a steamer head according to the first embodiment of the invention;

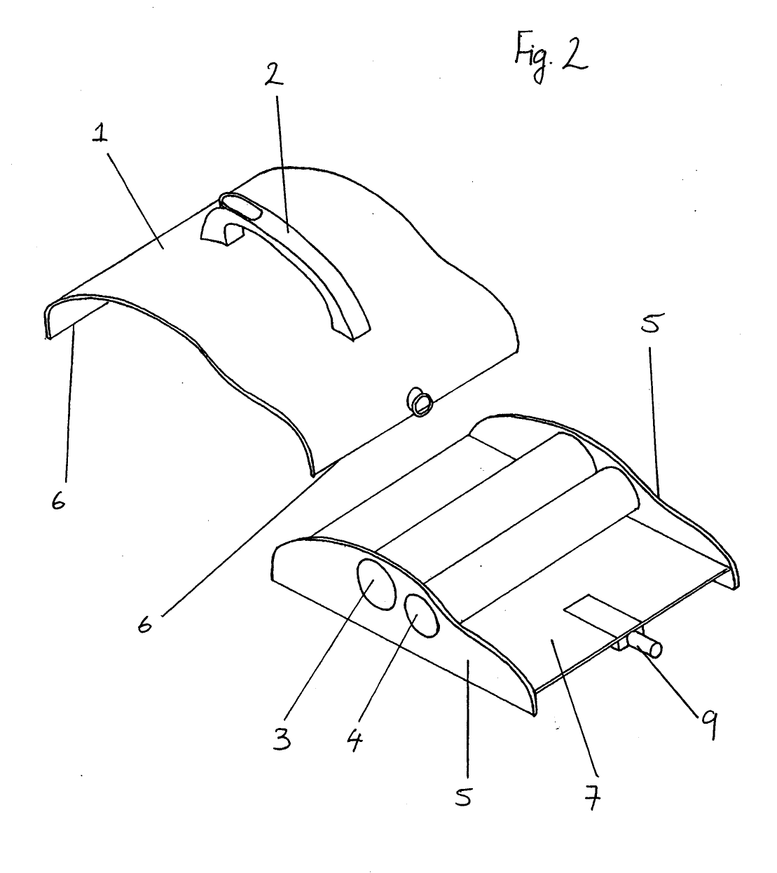

FIG. 2 is an exploded view of the steamer head shown in FIG. 1;

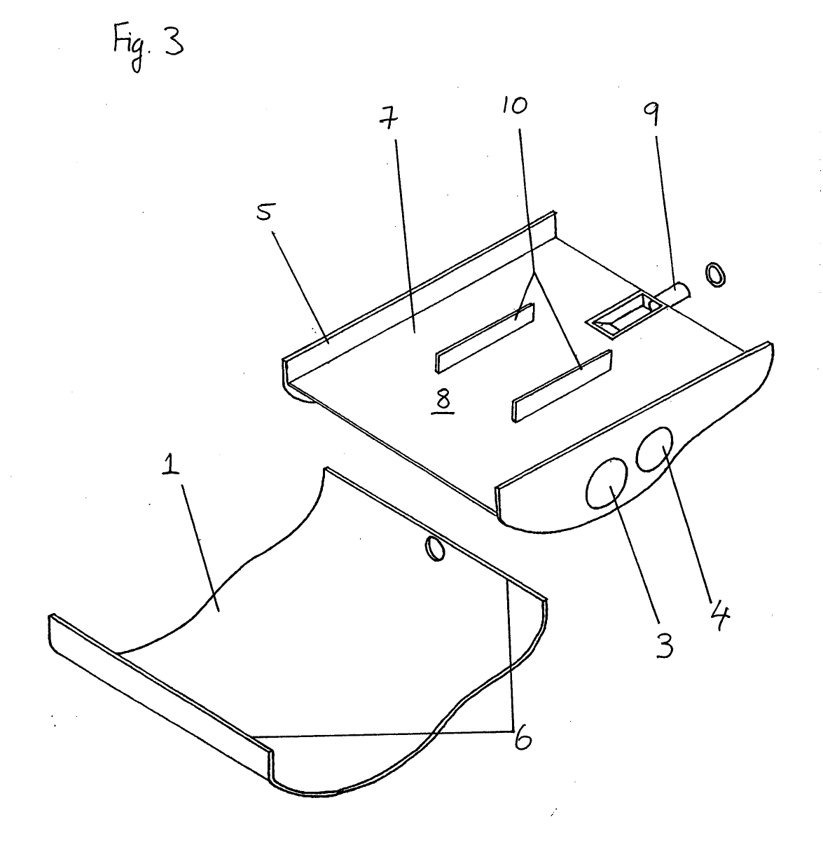

FIG. 3 is an exploded view from below the steamer head of FIG. 1;

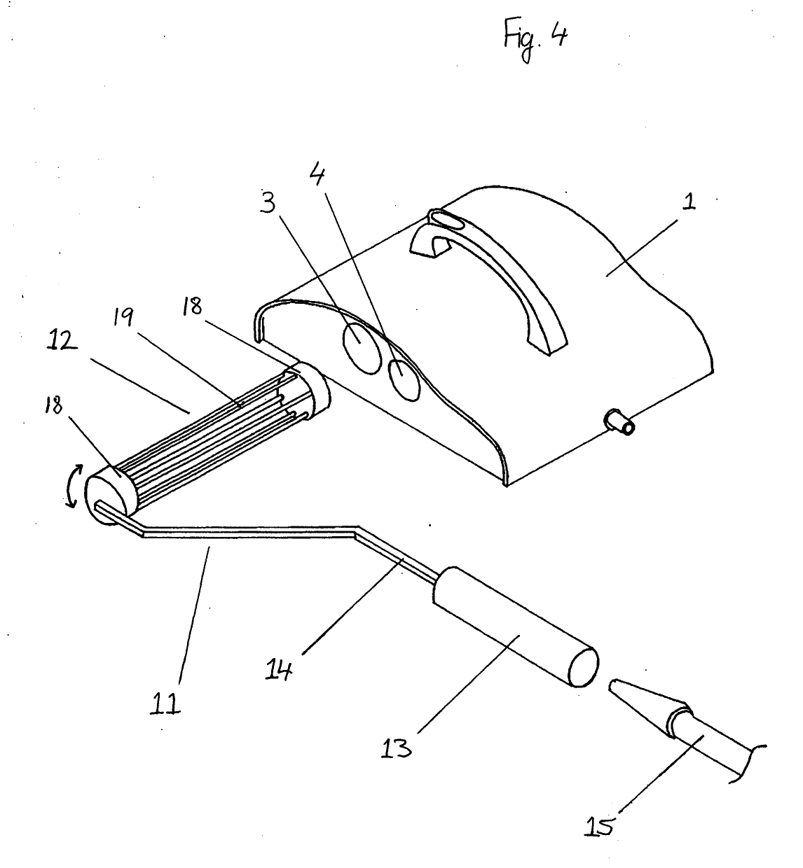

FIG. 4 is an exploded view of a steamer apparatus according to the second embodiment of the invention;

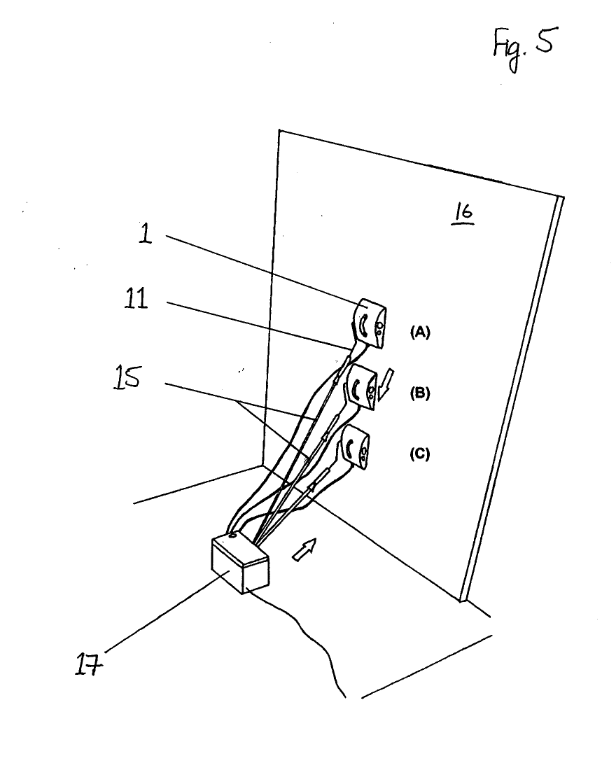

FIG. 5 shows the steamer apparatus shown in FIG. 4 in use;

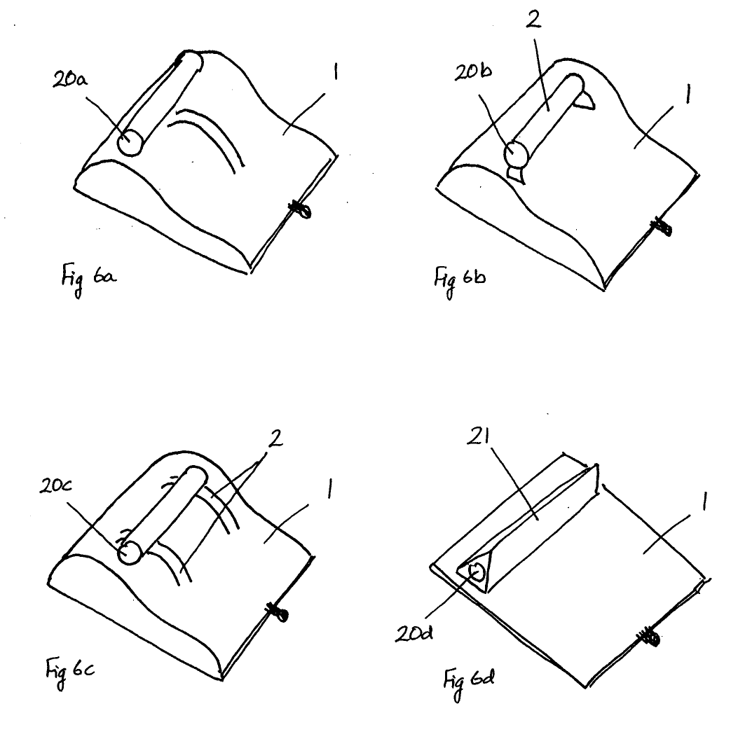

FIGS. 6a to 6d are perspective views of steamer heads of different embodiments;

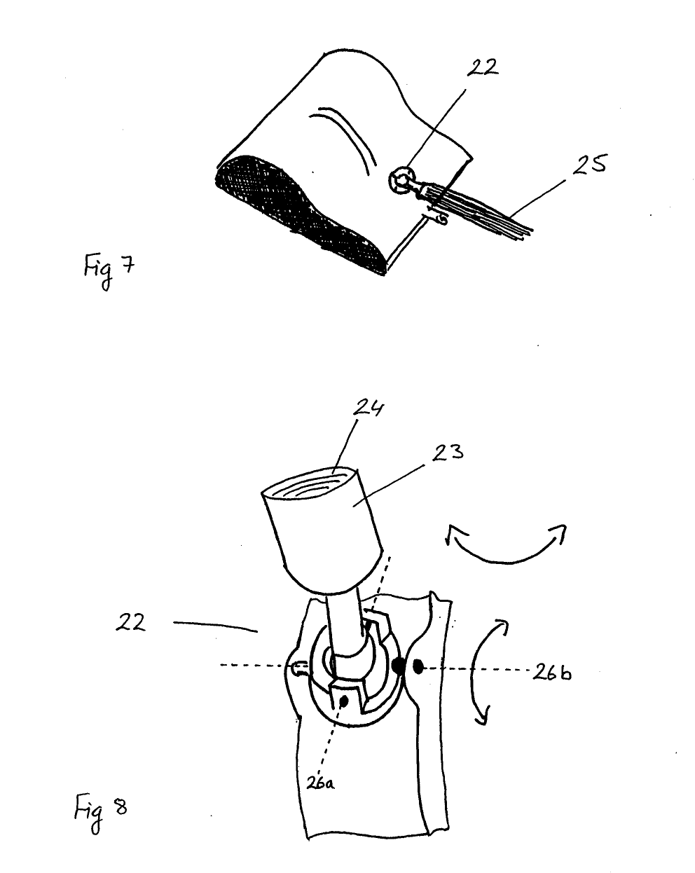

FIG. 7 is a perspective view of a steamer head of a different embodiment;

FIG. 8 is a detailed view of the two-way pivot joint shown in FIG. 7.

The steamer head seen in FIGS. 1 to 3 has a body 1, a handle 2 and two female coupling devices in the form of openings 3,4 which extend through the body. Side walls 5, ends 6 and a base plate 7 of the body 1 define a steam chamber 8. An adaptor 9 is provided on the body 1 for a tube (not shown) which is in communication with a steam production unit (not shown). Steam can therefore be fed from a steam production unit to the steam chamber 8 so that steam loosens a surface covering from a surface when the steamer head is located against the surface. Fins 10 on the base plate 7 provide support to the base plate 7 when the steamer head is pressed against the surface.

The openings 3,4 through the body 1 are formed as tubes connected to the side walls 5. In this example, the openings are open at both of their ends, though one end may alternatively be closed.

Each opening 3,4 can receive a male coupling device on a support member (not shown) to couple the steamer head to the support member for supporting the steamer head against a surface. Accordingly, the shape and diameter of each opening 3,4 is such that it frictionally engages the male coupling device inserted into the respective opening. The first opening 3 has a larger diameter than the second opening 4, thus enabling different sized male coupling devices to be coupled to the steamer head. In other embodiments, more than two differently sized openings or only one opening may be provided.

It is envisaged that the steamer head will be used with a support member comprising a paint roller connected to a shaft, as described in more detail below. The roller itself can be removed from the roller mount of the roller so that the roller mount can be inserted into one of the openings in the body to couple the paint roller to the steamer head.

Paint rollers, and therefore roller mounts, are commonly produced in a few standard diameters. The internal diameter of the openings in the body is therefore selected in light of these standard diameters. In this example, the first opening 3 is 44 mm in diameter and the second opening 4 is 37 mm in diameter. Other diameters for the openings may be chosen to accommodate other paint roller diameters or shapes, such as generally hexagonal etc.

The steamer head may have any suitable shape, and may be made of suitable materials, such as plastic materials.

FIG. 4 shows the steamer head of FIGS. 1 to 3 with a known paint roller 11 and a shaft 15. The roller of the paint roller 11 has been removed, uncovering the roller mount 12. The paint roller 11 also has a handle 13 and a neck 14. The roller mount is rotatable relative to the neck and handle.

To couple the steamer head to the paint roller 11, the roller mount 12 is inserted into the first opening 3 in the body. The roller mount fits snugly into the opening so that it frictionally engages the inner wall of the opening. Where a smaller diameter roller mount is used, this can be inserted into the second opening 4, since this has a smaller internal diameter.

The handle 13 of the paint roller 11 is hollow and receives an end of the shaft 15. Thus the paint roller 11 and the shaft 15 form the support member. The end of the shaft may be held by friction in the handle, or the two parts may be provided with co-operating threads for screwing. The length of the shaft 15 is adjustable, for example telescopically, or by being formed in connectable sections.

Since the roller mount 12 is rotatable relative to the neck 14 and handle 13, but is tightly received in the opening 3, the steamer head can rotate, or pivot, relative to the support member.

Further, since the paint roller 11 has an angled neck 14, the steamer head can be connected to the support member such that the shaft is aligned, or nearly aligned, with the centre of the steamer head. This means that the steamer apparatus is stable against slipping sideways when leaning against a wall.

FIG. 5 shows the steamer apparatus in use. When the steamer head is coupled to the support member, it can be leant against a wall 16 which is to be stripped of its covering. In this arrangement, the support member supports the steamer head against the wall allowing the user to do other activities. The user should preferably exercise reasonable care when attending to other activities to ensure the steamer apparatus operates safely. For example, the other activities may be carried out near the steamer apparatus.

In a first position (A), the steamer head is supported by the support member and is leant against a first region of the wall. The user can leave the steamer apparatus in this position for a few minutes while he attends to another job nearby, such as scraping steamed areas or perforating wallpaper. After a few minutes, the user returns to the steamer apparatus and adjusts the length of the shaft 15 to make it shorter. When the apparatus is leant against the wall again, in a second position (B), the steamer head is leant against a second region of the wall. The steamer head is then able to steam this second region, while the user scrapes the wall covering from the first region just steamed.

The process is repeated for a third region by arranging the steamer apparatus in a third position (C), and then for all other regions of the wall in turn.

The way in which the paint roller 11 enables the steamer head to pivot relative to the support member and the fact that the length of the shaft 15 is adjustable means that the steamer head can easily be placed against successive regions of a wall for steaming those regions in turn.

The end of the shaft 15 opposite the paint roller 11 can be placed on the ground, and may be placed against another, preferably heavy, item on the ground such as the steam production unit 17, as shown in FIG. 5. This ensures that the support member does not slip along the ground under its own weight and the weight of the steamer head. Using the steam production unit 17 in this way is advantageous since the unit 17 contains water and is therefore weighed down. If the steam production unit 17 is to be used in this way, ideally it does not have wheels. The item against which the shaft is placed may be formed with a notch or recess to receive at least part of the end of the shaft.

The steamer apparatus may also be used to strip a covering from a ceiling. In this case, the apparatus should be used with caution to avoid condensed steam falling onto the user and causing injury. It is an advantage of this invention that the support member can be positioned so that condensed steam falls in front of the user.

The paint roller 11 shown in FIG. 4 has a roller mount 12 comprising two end portions 18 connected by several rods 19 to form a roller cage. This roller cage is rotatably mounted at one end to the neck 14 of the paint roller 11. However, any other kind of paint roller can be used, providing it has at least one part which can frictionally engage the inner surface of one of the openings 3,4 and a part which can rotate relative to the neck and the handle of the roller.

In some embodiments, the roller is not removed from the paint roller 11 to uncover the roller mount 12. Instead, the roller is inserted into the opening 3,4.

In other embodiments, one or more female coupling devices are arranged on the body 1 of the steamer head, instead of providing openings 3,4 through the body. Examples of this are shown in FIGS. 6a to 6d. In these examples, only one female coupling device is shown, though two may be provided if desired. The female coupling device is arranged to receive a roller mount 12 or roller as described above.

The female coupling device shown in FIG. 6a is in the form of a tube 20a attached to the surface of the steamer head opposite the steam chamber 8. In FIG. 6b, the female coupling device 20b is again tubular, but it is mounted on the body 1 so as to act as a handle 2 for the steamer head. A tube 20c is also used in the steamer head of FIG. 6c, but this is attached to a pair of handles 2 in this example.

The steamer head shown in FIG. 6d is of a different shape to those shown in previous figures, though it operates in the same way. This steamer head is provided with a female coupling device in the form of an opening 20d extending through a block 21 attached to the surface of the steamer head opposite the steam chamber 8. The block 21 is shown to be triangular in cross-section, though various shapes could be used.

A further embodiment of the invention is shown in FIG. 7. The steamer head shown in FIG. 7 is generally the same as the steamer head shown in FIGS. 1 to 3, but the way in which the support member is coupled to the steamer head is different. In this embodiment, a two-way pivot joint 22, shown in more detail in FIG. 8, is connected to the surface of the steamer head opposite the steam chamber 8. The two-way pivot joint 22 carries a female coupling device 23. The inner surface of the female coupling device is threaded 24 so that it can be coupled to a threaded male coupling device carried on a support member 25. However, the female 23 and male coupling devices could optionally be provided with substantially smooth surfaces resulting in a frictional engagement.

By mounting the female coupling device 23 on a two-way pivot joint 22, movement of the steamer head relative to the support member about two pivot axes 26a, 26b is possible. This can be more versatile.

Alternatively, the female coupling device 23 may be fixed relative to the body 1 and the male coupling device 24 may be mounted on a two-way pivot joint connected to the support member.

The steamer heads shown in the figures are suitable for small scale use, for example domestic DIY use. The steamer head could instead be a commercial steamer having a larger body and a larger steam chamber which covers a greater surface area.

The above discussion refers to the use of the steamer head to steam wall and ceiling coverings. However, the steamer head and steamer apparatus is also suitable for use on other surfaces, such as doors, pillars and angled surfaces such as walls and ceilings.

1-20. (canceled)

21. A steamer apparatus for steaming surface coverings comprising a steamer head comprising a body and coupling means separably coupled to a support member for supporting the steamer head against a surface the support member including a shaft having a first end which is provided with a male coupling device, the first end being the handle and neck of a paint roller and the male coupling device being the roller mount of a paint roller, the handle being separably coupled to the shaft.

22. A steamer apparatus according to claim 21, wherein the coupling means of the steamer head comprises a female coupling device.

23. A steamer apparatus according to claim 22, wherein the female coupling device is an opening extending at least partially through the body, the opening being sized and shaped such that the roller mount of the paint roller is frictionally engagable with the inner surface of the opening.

24. A steamer apparatus according to claim 22, wherein the female coupling device is secured to a face of the body.

25. A steamer apparatus according to claim 24, wherein the female coupling device is sized and shaped such that it is frictionally engagable with the roller mount of the paint roller.

26. A steamer apparatus according to claim 24, wherein the female coupling device is mounted on the steamer head on a two-way pivot joint.

27. A steamer apparatus according to claim 22, wherein the coupling means comprises a second female coupling device of different dimensions to the first female coupling device so that the steamer head is couplable respectively to male coupling devices of different dimensions.

28. A steamer apparatus according to claim 21, wherein the steamer head and the support member are pivotable relative to each other.

29. A steamer apparatus according to claim 21, wherein the male coupling device is rotatably mounted on the first end such that its axis of rotation is generally perpendicular to the shaft.

30. A steamer apparatus according to claim 21, wherein the first end is configured such that the axis of the shaft is generally aligned with the centre of the steamer head.

31. A steamer apparatus according to claim 21, wherein the length of the support member is adjustable.
